(19) United States
(12) Patent Application Publication
(10) Pub. No.: US 2007/0125608 A1
(43) Pub. Date: Jun. 7, 2007

(54) Parking brake actuator system

(75) Inventors: Nicolai Tarasinski, Frankenthal (DE); Rainer Gugel, Mannheim (DE)

Correspondence Address: DEERE & COMPANY, ONE JOHN DEERE PLACE, MOLINE, IL, 61265, US

(73) Assignee: Deere and Company

(21) Appl. No.: 11/582,811

(22) Filed: Oct. 18, 2006

(30) Foreign Application Priority Data
Dec. 3, 2005 (DE) 10 2005 057794.6

(51) Int. Cl. F16D 55/16

(52) U.S. Cl. 188/72.9; 188/161

(57) ABSTRACT

A parking brake actuator system is provided for an agricultural or industrial utility vehicle. The system includes an actuating member and an actuator. The actuating member can be forced into an engaged position by means of a preload. An actuator moves the actuating member against the preload force. The actuating member includes a parking brake arm which pivots about an axis and engages, when it is in an engaged position, a rotatable component. To permit actuation with relatively low force and to reduce the tolerances required, the actuating member includes a toggle device. The toggle device and the parking brake arm cooperate so that the parking brake arm and the toggle device move in response to actuation of the actuator.

### BACKGROUND

The present invention relates to an actuator system for actuating a parking brake of a vehicle, in particular the parking brake of an agricultural or industrial utility vehicle.

Parking brake systems are critical to vehicle safety. The parking brake system prevents the vehicle from rolling away even in an un-powered condition. Usually a parking brake system includes a spring which is preloaded to urge the actuating mechanism into its engaged position of the parking brake, even when the vehicle is un-powered, so that an actuator cannot bring the actuating mechanism into the disengaged position against the preload. If the vehicle is stopped, for example, on a slope, gravity applies considerable forces to the components of the parking brake mechanism. In order to unlock the parking brake system in this case, correspondingly large forces are required. These forces are, in particular, a function of the friction relationships that result from the actual configuration of the parking brake system and the actuating mechanism.

John Deere tractors have a parking brake arm which is pivotally supported by bearings on one side in the gearbox housing. This arm pivots through an angle of a few degrees and can thereby block a gear fixed to the output shaft of the gearbox. The pivoting movement can be blocked by a rotatable shift gate. The shift gate is supported on the gearbox housing by a housing cover. The rotation of this shift gate is particularly problematic when the components of the parking brake system are under a high load, such as when the vehicle is stopped on a steep slope. In addition, the components of this configuration are subject to very tight tolerances, hence the manufacture of these components is very costly and during the assembly time-consuming reworks may become necessary.

### SUMMARY

Accordingly, an object of this invention is to provide a parking brake actuator system is relatively easy to actuate.

A further object of the invention is to provide such a parking brake actuator system in which the requirements for the tolerances are reduced.

These and other objects are achieved by the present invention, wherein the actuating mechanism includes a toggle device. The toggle device and the parking brake arm interact so that the movement of the parking brake arm can be performed by the toggle device as a function of an actuation of the actuator.

The toggle device is a toggle lever that can be folded in one direction and is movable between a folded condition and a stretched condition. The toggle lever is arranged relative to the parking brake arm so that the actuating mechanism can move into a disengaged position when the toggle lever is bent into its folded condition. In the stretched condition of the toggle lever, the parking brake arm is in an engaged position.

According to the invention, it has been recognized that, under certain circumstances, such as when the vehicle is stopped on a slope, a large force is required to move the parking brake arm out of its engaged position. In order to move the parking arm into a disengaged position from a known shift gate, high friction forces must be overcome under certain circumstances.

With the present toggle link configuration only the breakout force of the toggle joint configuration must be overcome in order to bring the parking brake arm into the disengaged position, and the toggle device can assume a folded condition without overcoming friction forces.

Preferrably, the toggle device has two arms or legs, pivotally connected to each other in joints, such as a fork link or an axle link, which only one degree of freedom relative to the rotation of the two arms or legs. The first arm of the toggle device could be supported in bearings, free to rotate, about an axis on a housing. Alternatively, or in addition the second arm of the toggle device could be pivotally coupled to the parking brake arm. The coupling between the first arm and the housing could also be provided by a fork link or an axle link. Such a pivotal coupling could be configured, for example, by means of a pin and a corresponding bore in each case in the housing and in the first arm. The pivotal coupling between the second arm of the toggle device and the parking brake arm could also be provided by a fork link or an axle link. Thereby such a pivotal coupling preferably also provides only one degree of freedom.

When the actuating system is in the engaged position, an end of the parking brake arm which is remote from its pivot axis is engaged in a positive lock with the rotatable component to be braked.

The distance of this end from the pivot axis depends, among other factors, upon the actual configuration systems and the available space for the parking brake arm.

The toggle device and the parking brake arm may be arranged relative to each other so that when the parking brake arm is in the engaged position, the longitudinal axes of the arms of the toggle devices are directed or oriented generally at right angles to the longitudinal axes of the parking brake arm. In other words, the toggle device is in a “stretched” position, and not in a folded position, when the parking brake arm is in the engaged position. The longitudinal axes of the two arms of the toggle device in the “stretched” condition, may extend at an angle to each other, that differs slightly from 180 degrees, in order to assure a folding of the toggle device in the same direction on each occasion.

A limit surface is provided to limit a deflection movement of the toggle device in at least one direction. Such a limit surface could be formed on the housing in which the parking brake is enclosed or mounted. Moreover, such a limit surface could be formed by a component fastened to the housing, such as a block. In this direction also an angle differing slightly from 180 degrees could occur that would achieve an assurance against laying out or disengagement. Now the actuator could be actuated mechanically, hydraulically or pneumatically.

Preferably, the actuator includes a piston that can be actuated mechanically, hydraulically or pneumatically. Such a piston could also be moved electrically. A part of the toggle device could be arranged between the piston and the limit surface, and in particular the pivotal coupling between the two arms. Thereby, only small forces are required to to bring the folded toggle device into its “stretched” condition. The toggle device can perform a deflection movement when the piston is actuated accordingly, that is when the piston surface of the piston that interacts with the toggle device is arranged at a distance to the limit surface.

Preferrably, the actuator includes an electromagnet and a moveable armature. The moveable armature could be arranged in a housing in which the parking brake is arranged and could be guided and/or limited relative to its movement, by corresponding guiding devices. The armature then moves when the electromagnet is activated or deactivated. For this purpose, the armature is configured so that it is attracted or repelled by the magnetic field of the electromagnet. The armature could be manufactured of metal, particularly of iron or steel, so that the armature is attracted by a magnetic field generated by the electromagnet. Alternatively, the armature could be provided by a permanent magnet material so that it is repelled by the magnetic field of the activated electromagnet.

The electromagnet includes a core and at least one coil. The core of the coil or the core of the electromagnet could be provided with a soft iron material that has the effect of providing a high amplification of the magnetic field generated by the coil. The core could preferably be provided with a stacked sheet metal packet.

Preferably, the electromagnet is provided with two coils that are wrapped or arranged about the same core. The coils of the electromagnet could be controlled by a control unit and an electrical current step could be provided so that when the first coil of the armature is supplied with current it performs a predetermined movement. In order to perform a predetermined movement of the armature both coils could also be simultaneously supplied with current by the control unit. The second coil may be supplied with a predetermined current (holding current) of appropriate current density to retain the armature at an end stop position.

Alternatively, two electromagnets could be provided, or, a single electromagnet could have two coils. Only when both coils are supplied with current or both electromagnets are activated then a movement of the armature can be performed. If only one coil is supplied with current or the activation of only one electromagnet then the armature can be retained in an end stop position but cannot be moved. This requires that the coils or the electromagnets be dimensioned according to a force limitation and are controlled appropriately. Thereby among other factors, also for reasons of safety, an actuation of the parking brake is possible only when both coils or both electromagnets are activated.

Preferrably, the electromagnet is controlled as described in patent application DE 10 2005 039 263, the entire contents of which is incorporated herein by reference. This is provided for the cases in which the electromagnet is provided with one or two coils.

If the armature is to be brought into a condition in which it must be moved against a preload, the coil of the electromagnet is supplied with current of a predetermined first current. This first current is sufficient so that the force applied by the magnetic field of the electromagnet to the armature is of such a magnitude that the armature can be moved against the preload.

To retain the armature in such a condition in which it was to be moved against a preload and where the armature, for example, is in contact with the core of the electromagnet, the coil of the electromagnet is supplied with a predetermined second current, where the second current is smaller than the first current. The armature is attracted by the magnetic field of the electromagnet. Since in this condition the armature is closer to the electromagnet, then it is sufficient to retain the armature in this position with the smaller second current, since at a smaller spacing of the armature from the electromagnets the magnetic field is nevertheless sufficiently strong. Thus, the retaining current required is only a fraction—for example, ⅕ or ⅙—of the electric current of the first current required to move the armature. A coil, in each case, can be supplied with a first and second predetermined current, as described in DE 10 2005 039 263. The coil of the electromagnet could be supplied with the first predetermined current and a second coil be supplied with the second predetermined current as described in DE 10 2005 039 263.

In order to move the armature away from the electromagnet the coil of the electromagnet is then not supplied with electric current. The armature is very simply moved away from the electromagnet by interrupting the current flow through the electromagnets on the basis of the preload. As a result, when the current is interrupted the parking brake system is automatically in the blocked position or the actuating mechanism of the parking brake is in its engaged position.

Although the disclosure of DE 102005 039 263 is incorporated herein, it should be emphasized that the electromagnet current may be pulsed or pulse-width modulated. This reduces the energy required to retain the armature in the position in which the preload is to be overcome is very small.

Particularly in the case of a tractor, such as an agricultural or industrial utility vehicle, the component that is to be braked is provided with a wheel or gear arranged on the output side relative to the drive line of the utility vehicle, which is connected so as to drive at least one wheel or gear of the utility vehicle, where such a rotary connection preferably cannot be disengaged by a clutch.

### BRIEF DESCRIPTION OF THE DRAWINGS

FIG. 1 is a schematic diagram of a known prior art vehicle parking brake actuator system;

FIG. 2 is a schematic diagram of a parking brake actuator The actuator system of the present invention, showing it in a disengaged position;

FIG. 3 is a schematic diagram of the parking brake actuator system of FIG. 2 in an engaged position; and

FIG. 4 is a schematic diagram of a further embodiment of a parking brake actuator system.

### DETAILED DESCRIPTION

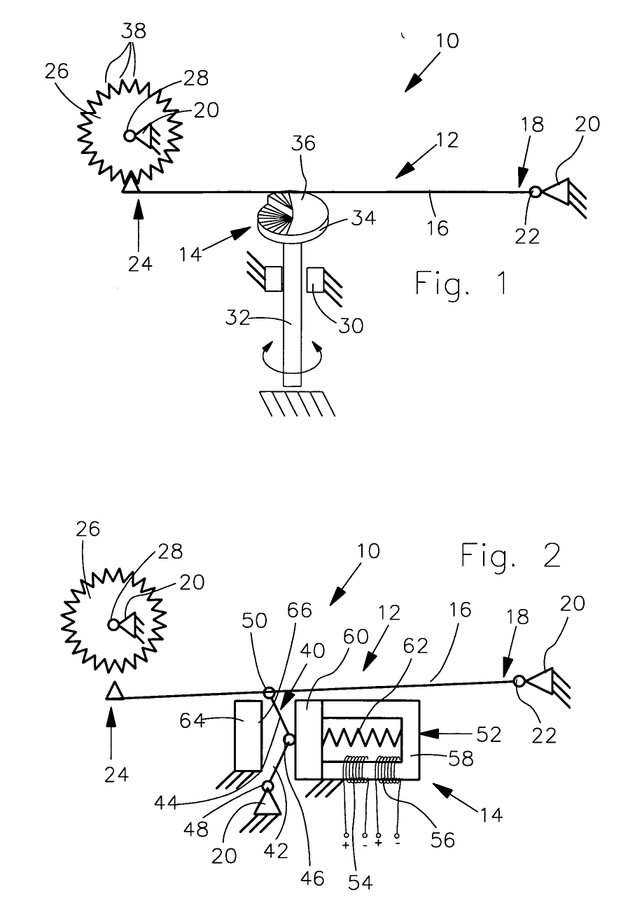

A known prior art parking brake actuator system 10 includes an actuating mechanism 12 with an actuator 14. The actuating mechanism 12 includes a generally elongated parking brake arm 16 with an end 18 pivotally supported in bearings with respect to a housing 20 with a pivot axis 22 which is perpendicular to the plane of FIG. 1. The parking brake arm 16 has a second end 24 that can be brought into engagement with the gear 26. The gear 26 is rotatably supported by shaft 28 on a housing 20. The shaft 28 is connected directly or indirectly so as to rotate with at least one wheel (not shown) of the vehicle (not shown). In this embodiment this rotary connection between the shaft 28 and the wheel cannot be interrupted in any case, for example, by a clutch.

The actuator 14 includes a shaft 32 rotatably supported by bearing 30. An end of the shaft 32 facing the parking brake arm 16 carries a cylindrical component 34 with a shift gate shaped surface 36. The actuator 14 is arranged so that, upon a rotation of the actuator 14 or of the shaft 32 about the axis of shaft 32, the parking brake arm 16 will pivot about the axis 22, so that the second end 24 of the parking brake arm 16 can be brought into the disengaged position.

To disengage the second end 24 of the parking brake arm 16 from the teeth 38 of the gear 26, the actuating mechanism 12 must overcome any frictional force which resists disengagement of the second end 24 of the parking brake arm 16 from the teeth 38 of the gear 26.

Referring now to FIG. 2, the parking brake arm 16 is in the disengaged position the second end 24 of the parking brake arm 16 is disengaging from the teeth of the gear 26 so that gear 26 and the shaft 28 can rotate. Correspondingly, the parking brake arm 16 of FIG. 1 can be moved to the disengaged position shown in FIG. 2.

According to the invention, the actuating mechanism 12 include a toggle device 40. The toggle device 40 and the parking brake arm 16 interact so that the parking brake arm 16 can be moved in response to actuation of the actuator 14.

The toggle device 40 includes two elongated straight arms 42 and 44. The first arm 42 has one end pivotally coupled at joint 46 with the second arm 44. The other end the first arm 42 is pivotally coupled at joint 48 to the housing 20. Here too, this is an axle joint connection. The second arm 44 is pivotally coupled by joint 50 to the parking brake arm 16. This joint is 46, 48 and 50 are preferably axle link connections which permit rotation in only one degree of freedom, about axis which are perpendicular to the plane of the FIG. 2.

The parking brake arm 16 has its first end 18 pivotally coupled to the housing 20 and its second end 24 engagable with a rotatable component 26. The second arm 46 of the toggle device 40 is coupled to the parking brake arm 16 at joint 50 which is closer to the second end 24 then to the first end 18. By such an arrangement, the effective lever arms results in a favorable force balance of the actuating mechanism 12 for the actuation of the parking brake arm.

The actuator 14 of FIG. 2 includes an electromagnet 52 which has two coils 54, 56 and a core 58 fixed with respect to the housing. The actuator 14 also includes an armature 60 which moves linearly and which is guided by means of guidance devices (not shown). Accordingly, the armature 60, is moved by the magnetic field generated by the electromagnet 52.

A spring 62 is fastened at one end to the core 58 of the electromagnet 52 and at its other end to armature 60, and is biased or preload to urge the armature 60 towards the toggle device 40 and stop 64. The stop 64 is fixed to a housing (not shown) and forms a limit surface 66. In FIG. 2 the toggle device 40 is in a folded condition, and the armature 60 is held against the core 58 and spaced away from the limit surface 66. Accordingly, joint 46 is positioned between the limit surface 66 and the armature 60.

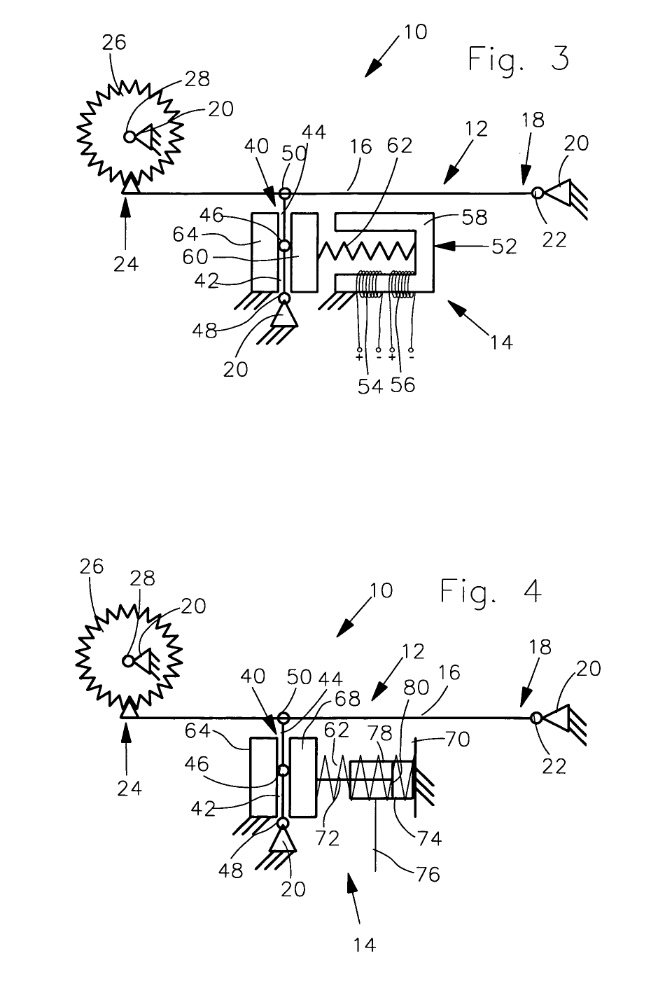

Referring now to FIG. 3, the actuating mechanism 12 is in the engaged position. Accordingly, the toggle device 40 is in its stretched condition and the armature 60 is near to the limit surface 66 of stop 64. In this position arms 42 and 44 are oriented perpendicular to the longitudinal axis of the parking brake arm 16.

As seen in FIGS. 2 and 3, the electromagnet 52 includes two coils 54, 56. They are connected electrically to an electric power unit (not shown) and to a corresponding control unit (not shown). To move the armature 60 to the right against the preload of spring 62, the first coil 54 is supplied with a predetermined current. This causes the electromagnet 52 to generate a magnetic field which attracts the armature 60 and overcomes the preload of the spring 62 acting in the opposite direction. When the armature 60 is in the right position shown in FIG. 2, only the second coil 56 is supplied with a second predetermined current which is smaller than the current applied to the first coil 54 in order to move the armature 60. Thus, the electromagnet 52 and the coils 54, 56 are controlled according to a process described in German patent no. DE 10 2005 039 263.

Referring now to FIG. 4, the actuator 14 includes an actuator member 68 instead of the armature 60 of FIGS. 2 and 3. Actuator member 68 is rigidly connected by a piston rod 72 to a piston 80 which moves in a piston housing 74. A spring 62 is biased to urge the actuator member 68 into its left position. The left end of spring 62 is fastened to the actuator member 68 and the right end of spring 62 is attached to the housing 70. Hydraulic fluid can be supplied to or drained from a piston rod chamber 78 via supply line 76. When pressurized hydraulic fluid is supplied to the piston rod chamber 78 then the piston 80, piston rod 72 and actuator member 68 move to the right. In FIG. 4 the actuator 14 is in an extended position, and chamber 78 can be pressurized to move actuator 14 to a retracted position. The actuator 14 of FIG. 4 could also be actuated hydraulically or pneumatically.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. An actuator system for actuating a parking brake of a vehicle, the actuator system having actuating member which is urged into an engaged position by a preload, and which is movable by an actuator to a disengaged position against the preload, where the actuating member comprises a pivotal parking brake arm which is engagable with a rotatable component, wherein:
the actuating member includes a toggle device coupled to the actuator and coupled to the parking brake arm so that the toggle device moves the parking brake arm in response to actuation of the actuator.

2. The actuator system of claim 1, wherein:
the toggle device comprises first and second arms pivotally coupled to each other at a pivot joint.

3. The actuator system of claim 2, wherein:
the first arm is pivotally coupled to the housing and the second arm is coupled to the parking brake arm.

4. The actuator system of claim 1, wherein:
the parking brake arm is pivotal with respect to a housing about a pivot axis; and
the parking brake arm includes a part which is spaced away from the pivot axis and which is engagable with a rotatable component when the actuating member is in the engaged position.

5. The actuator system of claim 3, wherein:
the parking brake arm has a first end pivotally coupled to a housing and a second end engagable with a rotatable component, and the second arm of the toggle device is coupled to the parking brake arm at a joint which is closer to the second end then to the first end.

6. The actuator system of claim 2, wherein:
the arms of the toggle device are oriented generally perpendicular to the parking brake arm of when the parking brake arm is in the engaged position.

7. The actuator system of claim 1, further comprising:
a limiting member having a limit surface which is engagable with the toggle device to limit motion of the toggle device in one direction.

8. The actuator system of claim 1, wherein:
the actuator includes a pressure operated piston.

9. The actuator system of claim 1, wherein:
the actuator operates mechanically, hydraulically or pneumatically.

10. The actuator system of claim 7, wherein:
the actuator includes a pressure operated piston; and
a portion of the toggle device is positioned between the piston and the limit surface, the toggle device performing a deflecting movement in response to operation of the piston.

11. The actuator system of claim 1, wherein:
the actuator comprises an electromagnet and a moveable armature.

12. The actuator system of claim 12, further comprising:
a limiting member having a limit surface which is engagable with the toggle device to limit motion of the toggle device in one direction, and at least a portion of the toggle device is arranged between the moveable armature and the limit surface, and the toggle device perform a toggle motion in response to movement of the armature towards and away from the limit surface in response to operation of the electromagnet.

13. The actuator system of claim 11, wherein:
the electromagnet comprises a core and a coil.

14. The actuator system of claim 11, wherein:
the electromagnet comprises a core and first and second coils, the first coil being energizable to move the armature, and the second coil being energizable to hold the armature in an end stop position.

15. The actuator system of claim 15, wherein:
the rotatable component comprises a gear.
